(19) United States
(12) Patent Application Publication
(10) Pub. No.: US 2012/0259744 A1
(43) Pub. Date: Oct. 11, 2012

(54) SYSTEM AND METHOD FOR AUGMENTED REALITY AND SOCIAL NETWORKING ENHANCED RETAIL SHOPPING

(75) Inventors: Jai GANESH, Bangalore (IN); Tarun Prakash SHARMA, Dehradun (IN); Mukund RAJ, New Delhi (IN); Christin Elisabeth STAUBO, Oslo (NO); Joseph Maloba MAKOKHA, Hayward, CA (US)

(73) Assignee: INFOSYS TECHNOLOGIES, LTD., Bangalore (IN)

(21) Appl. No.: 13/346,437

(22) Filed: Jan. 9, 2012

(30) Foreign Application Priority Data
Apr. 7, 2011 (IN) 1186/CHE/2011

(51) Int. Cl. G06Q 30/00

(52) U.S. Cl. 705/27.2

(57) ABSTRACT

An augmented reality system is necessary for providing assistance for the customer in retail purchase decision. The augmented reality system comprising a one data sending module which is configured to send retail product information to the central server module is provided. A central server module configured to receive the retail product information from the data sending server where, the central server module is attached to a processor to process the retail product information. Processing the retail product information at the central server module, wherein the central server module retrieves retail product information from multiple databases which contains the retail product information. A data receiving module configured to receive the retail product information from the central server module. An application server configured to accept input from a user and to share the user details with a social networking platform.

This application claims the benefit of Indian Patent Application Filing No. 1186/CHE/2011, filed Apr. 7, 2011, which is hereby incorporated by reference in its entirety.

### FIELD OF THE INVENTION

The present disclosure relates to augmented reality and social networking enhanced retail shopping in physical store as well as online stores. The present disclosure will provide an immersive shopping experience for retail customers.

### BACKGROUND

Enterprises are increasingly adopting technologies which offer immersive experiences for their end customers. This is particularly the case with retail industry with increasing competitive pressures, the need to differentiate, expand reach to the consumer, improve conversion, and sustain customer loyalty. With non-store retail sales poised for strong growth and likely to grow into a significant chunk of total retail business, retailers are seeking answers to issues such as differentiating user experience on their points of interaction, increasing reach to the consumer, improving conversion rates on the website, sustaining consumer loyalty, etc. Existing approaches attempts to solve the problem of customer purchase decisions by comparing products based on features separately and displaying user comments. The existing approaches do not link the products based on features and the user comments in showing the results. Also, existing technologies do not combine the benefits of immersive user experiences provided by augmented reality with social shopping experiences. However, improvements are always desired in any art.

### SUMMARY

Aspects of the disclosure relate to enhancing customer purchase decision by combining immersive user experiences and social network related information. This disclosure will help improve customer decision making process, by displaying three dimensional images of customer preferred products and enhancing that information with data from the user's social network.

The present disclosure works in two phases. First it helps the user to reach the destination by providing augmented information that directs the user toward the building containing the product and eventually to the product itself. After the user has the product in sight, the next phase of the disclosure is triggered which provides the user with information gathered from various sources from the Internet in an augmented reality format by attaching the information virtually to the object in the video feed.

According to the present disclosure, a uniquely marked image of the retail product is provided. The image of the retail product is accepted as an input through a digital device which, for example, can be a camera. The image once accepted is displayed on an output device in the form of a three dimensional image or in the form of a video clip. The output device can be PC, Mobile, Television, Kiosks as well as Head Mounted Displays. The retail product details such as name of the product, product code, product type is sent to databases, for example Twitter™, YouTube™, Delicious™, Flickr™, Amazon™, Technorati™ etc through a communication channel which can be in the form of internet. The product information such as recent Twitter™ feeds, review videos on YouTube™, user ratings from Amazon™, images from Flickr™ can be retrieved in real time. An embodiment in the present disclosure also provides for social media and social network related options such as asking the network for ideas, choosing a friend to ask for expert help, engaging in a Skype™ chat as well as receiving feedback from the user's social network.

### BRIEF DESCRIPTION OF THE DRAWINGS

These and further features of the present disclosure are better understood by reading the following detailed description of the drawing, wherein,

FIG. 1 is a flow chart of an exemplary embodiment of the present disclosure.

FIG. 2 is a block diagram of an exemplary embodiment of the present disclosure.

FIG. 3 is a block diagram of an exemplary embodiment of the present disclosure.

FIG. 4 is a system illustrating a generalized computer network arrangement, in one embodiment of the present disclosure

### DETAILED DESCRIPTION OF THE INVENTION

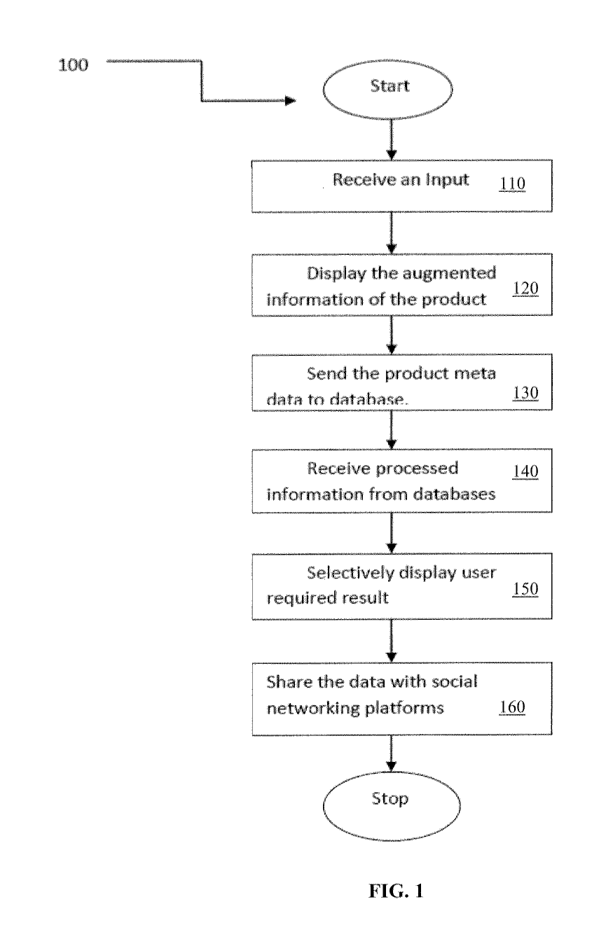

The present disclosure proposes a method for users to overlay Augmented Reality based product information with information from social networking destinations including Twitter™, Facebook, Google Buzz, etc. FIG. 1 is a flow chart of an exemplary embodiment of the present disclosure. The method includes; block 110 wherein input is received using a digital device which can be a digital camera. The digital camera can be enclosed within mobile phone, pen, a watch or any digital medium which can be enclosed with a camera. The input can be an image that is uniquely marked or it can also be a product with a distinguishing mark on it. The digital device identifies the product by the unique mark on the retail product. The process in block 120 describes identifying and displaying the retail product. Based on information captured by the digital device, information regarding the retail product in augmented reality form is fetched from the application database and displayed on to the output screen.

According to one embodiment of the present invention, the augmented information of the retail product can be a three dimensional image. The format of the image can be in any of the commonly available standards. According to another embodiment of the present invention, the augmented information can also be a video clip.

The format of the video clip can be in any of the commonly available standards. The augmented information of the product is retrieved from an application database. The block 130 describes a process of the present disclosure wherein the pre-defined retail product metadata is sent to a plurality of databases. The plurality of database can include one or more of Twitter™, YouTube™, Amazon™ etc to retrieve product relevant information. The retail product metadata includes product name or product keyword, model number of the product among other identifiers.

The product details such as name of the product, product code etc is sent to a plurality of databases through a communication channel which can be an internet connection. The internet connection can be a wireless connection, or a wired connection or any known connection techniques. The plurality of databases can be Twitter™, YouTube™, Amazon™ etc. The communication can be established with these databases using application program interface.

The block 140 describes a process of receiving processed predefined retail product information from the plurality of databases. The information that can be received includes, but is not limited to, the latest comments regarding the product retrieved from micro-blogging websites like Twitter™, recent videos of the product retrieved from video sharing websites like YouTube™, ratings or user feedback from online marketplaces or review websites like Amazon™ or eBay™, the locations or stores from which the product can be purchased from web-based map services like Google Maps and also the price or availability of the retail product.

Block 150 describes selectively displaying product related data which is gathered from the process of block 140. The process of block 150 contains option of selectively displaying specific information about the product, ratings retrieved from retail websites and websites containing publicly available rating of the product, current deals and related products on request by the user. A map is provided for indicating a set of location with information and pointers for additional nearby locations where one can find related products. The map for example can be a Google Map™.

At step 160 the processed predefined retail product information such as but not limited to images, textual description of the product, video reviews, Amazon™ ratings, price etc are shared through at least one application in real time such as Facebook™, Skype™ etc by the user. The step also includes displaying social media and social network related details such as to ask the network for ideas, choose a friend to ask for expert help, engage in Skype™ chat as well as receive feedback from the user's social network.

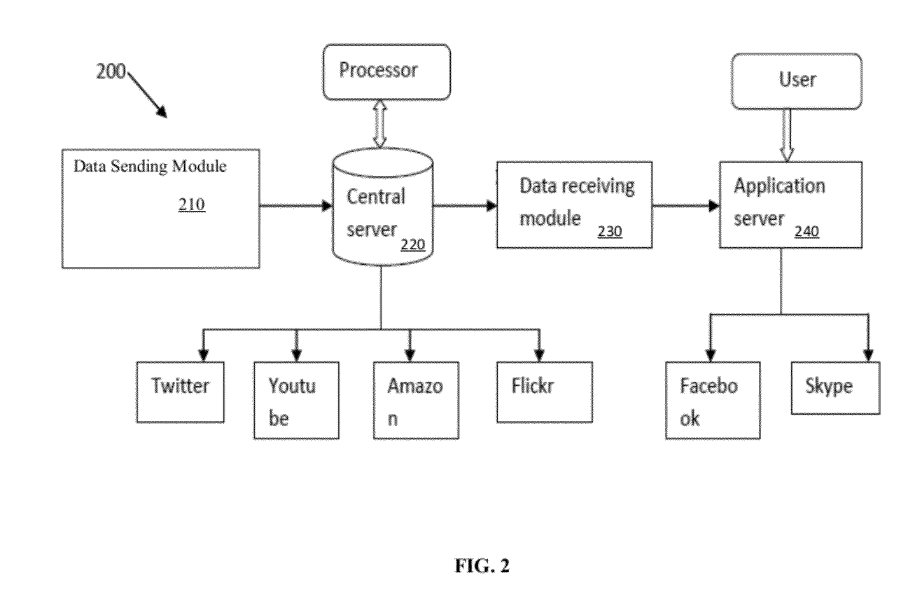

FIG. 2 is a flow chart of an exemplary embodiment of the present disclosure. The present disclosure proposes a system to provide for augmented reality collaborated with social networking to assist the customer in purchase decisions. The block 210 receives an input captured from a digital device which can be a digital camera or an image scanner. The input can be an image that is uniquely marked or it can also be the product itself which has a distinguishing mark on it. The digital device identifies the product by the unique mark on the retail product. When the object under observation comes in the view of the camera, it is detected and the data sending modules sends at least one query to all websites that are integrated e.g. YouTube™, Twitter™ for latest updates with the product keyword. This is done using the respective application program interface calls. Also additional data from an application database can be retrieved for primary augmented reality display object, for example, a three dimensional model of the object or a short movie clip if object is a movie DVD.

Block 220 represents a central server. The central server is tied to a processor which receives the data from the data sending module. A means for processing the retail product information includes: a central server with the help of a processor which fetches Web page content for the user provided URL(s) by connecting to the Internet. Once the page source is obtained, the central server 220 can parse and generate a Crawler XML. While generating the Crawler XML it also filters out unwanted information from the page source, that is, it collects the metadata on the page elements which are of interest and required for the next modules of the present invention. This Crawler XML is then used by the analysis/rules engine for applying the Social Intelligence guidelines, which include, accessing social networking websites only and showing the relevant results to the users. The crawler can also make API calls to web services APIs from networks such as Facebook™, Twitter™, Flickr™ etc. The central server also interacts with databases such as Facebook™ to get reviews of the product, Twitter™ to receive the latest and live tweets, YouTube™ for the video of the product review, Amazon™ to get the user ratings etc. The communication between the central server and the multiple databases happens through a communication channel which can be an internet connection. The internet connection can be a wireless connection, wired connection or any know communication techniques.

Further, in FIG. 2 block 230 represents a data receiving module. The data receiving module receives data retail product information from the central server. The data receiving module further comprises an information module. The information module can perform functions such as: displaying specification information about the product, ratings retrieved from retail websites and websites containing publicly available rating of the product, current deals and related products.

Further, a web based map services is provided with information with pointers for additional nearby locations where one can find related products. It can receive product details such as price, availability, specification, description and images of the product. Block 240 represents an application server which is tied to the data receiving server and also can be configured to receive input from the user. The application server also displays social media and social network related details such as ask the network for ideas, choose a friend to ask for expert help, engage in Skype™ chat as well as receive feedback from the user's social network. The application server is the basic modules of the system which interacts with the user. The application server collects data entered by user validate it and send to other module for processing. Once the process by other modules is completed successfully results are generated and shown to end user. The user can view this information from the application server on an output device which can be a mobile device, a personal computer, a Kiosk, a television or a head mounted display.

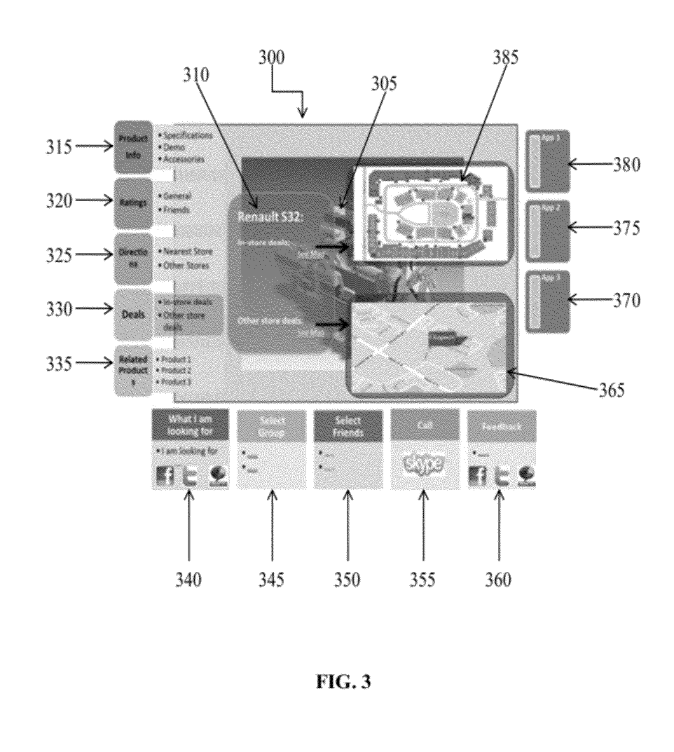

The embodiment of the disclosure can be further explained considering an example. FIG. 3 is a block diagram of an exemplary embodiment of the present disclosure. Block 300 represents an exemplary embodiment of the present disclosure. When the object under observation comes in the view of the digital device which is a camera, the unique mark enclosed on the object is detected and the corresponding three dimensional image 305 or a video clip in any standard format is gathered from the application database and displayed on the output screen. The output screen can be any one of the following but not limited to a PC, terminal, a hand held device, a kiosk, a head mounted display etc. A query containing a predefined retail product metadata is sent to a plurality of databases which includes all social networking sites that are integrated e.g. YouTube™, Twitter™ for latest updates with the product key word, through a communication channel. The communication channel can be a internet connection, wherein the internet connection can be a wired connection or a wireless connection. The interaction with the social networking sites is done using the respective application program interface. On receiving the processed predefined retail product information from the plurality of databases, they are selectively displayed as per the user requirements.

Block 310 indicates an example of the specification of the product. The processed predefined retail product information can be viewed on the output display categorically based on the requirements. For example, block 315 represents product information that is received from various sources available on the internet. Block 320 represents the user ratings received from Amazon™. Block 325 represents the option of viewing a geographical map. The geographical map indicates a set of location from which the retail product can be purchased.

Block 365 is one of the embodiments of the present disclosure where a graphical representation of the direction indicated by Google Map™, which is integrated with the present disclosure. A Google Map™ is provided with information and pointers for additional nearby locations where one can find related products.

Block 330 and 335 represents the details of the product retrieved from BestBuy™. Processed retail product information which is received from BestBuy™ includes price, availability, specification, description and images of the product. The processed retail product information can shared with public using Facebook™ etc. The user can post updates to their profiles requesting opinion regarding the product. A customizable message containing the product specifications is posted on their profile from here. The replies from the website are organized under various categories for the user represented in block 360. The user can choose to see replies for specifically the latest query, a trusted group of friends represented in block 345 and/or all recent friend updates represented in block 350 with the product name string within the update.

Block 360 represents embodiment of the present disclosure which allows the user engage in Skype™ chat as well as receives feedback from the user's social network. Block 370, 375 and 380 are embodiments of the invention that are tied to a plurality of databases such as YouTube™, Twitter™ etc where the user can view the latest comments regarding the product retrieved from micro-blogging websites like Twitter™, recent videos of the product retrieved from video sharing websites like YouTube™.

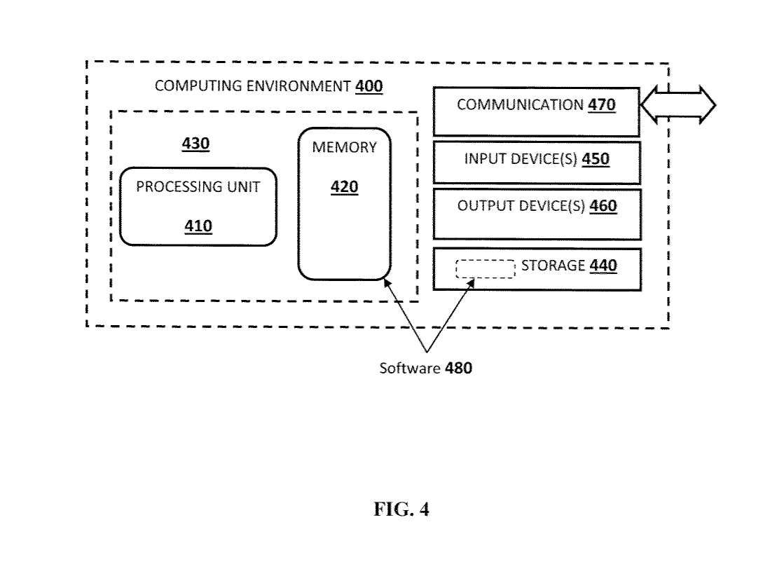

One or more of the above-described techniques may be implemented in or involve one or more computer systems. FIG. 4 illustrates a generalized example of a computing environment 400. The computing environment 400 is not intended to suggest any limitation as to scope of use or functionality of described embodiments.

With reference to FIG. 4, the computing environment 400 includes at least one processing unit 410 and memory 420. In FIG. 4, this most basic configuration 430 is included within a dashed line. The processing unit 410 executes computer-executable instructions and may be a real or a virtual processor. In a multi-processing system, multiple processing units execute computer-executable instructions to increase processing power. The memory 320 may be volatile memory (e.g., registers, cache, RAM), non-volatile memory (e.g., ROM, EEPROM, flash memory, etc.), or some combination of the two. In some embodiments, the memory 420 stores software 480 implementing described techniques.

A computing environment may have additional features. For example, the computing environment 400 includes storage 440, one or more input devices 450, one or more output devices 460, and one or more communication connections 470. An interconnection mechanism (not shown) such as a bus, controller, or network interconnects the components of the computing environment 400. Typically, operating system software (not shown) provides an operating environment for other software executing in the computing environment 400, and coordinates activities of the components of the computing environment 400.

The storage 440 may be removable or non-removable, and includes magnetic disks, magnetic tapes or cassettes, CD-ROMs, CD-RWs, DVDs, or any other medium which may be used to store information and which may be accessed within the computing environment 400. In some embodiments, the storage 440 stores instructions for the software 480.

The input device(s) 450 may be a touch input device such as a keyboard, mouse, pen, trackball, touch screen, or game controller, a voice input device, a scanning device, a digital camera, or another device that provides input to the computing environment 400. The output device(s) 460 may be a display, a television, a hand held device, a head mounted display or a Kiosk that provides output from the computing environment 400.

The communication connection(s) 470 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 400, computer-readable media include memory 420, storage 440, communication media, and combinations of any of the above.

Having described and illustrated the principles of our invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A method comprising the steps of:
receiving a predefined retail product as an input through a digital device, the displaying the predefined retail product on an output display in the form of a three dimensional image;
sending a predefined retail product metadata through a communication channel to a plurality of databases;
receiving a processed predefined retail product information from the plurality of databases; and
sharing the processed predefined retail product information to at least one application in real time.

2. The method of claim 1 wherein receiving a predefined retail product through a digital medium is, flashing the predefined retail product with a unique mark against a camera.

3. The method of claim 1 wherein the step of receiving the processed predefined retail product information from the plurality of databases further comprises displaying the predefined retail product information on request by a user.

4. The method of claim 1 wherein the step of displaying the three dimensional image on the output display further comprises sharing with the at least one application at least one of:
a textual data;
a three dimensional image; and
a video clip.

5. The method of claim 1 further comprises receiving augmented information from an application database.

6. The method of claim 6 wherein the step of receiving augmented information from the application database further comprises displaying the augmented information on the output display.

7. The method of claim 1 wherein the step of sending the predefined retail product metadata through a communication channel to the plurality of databases further comprises communicating with the plurality of databases using application program interface.

8. The method of claim 1 wherein the step of receiving the predefined retail product information from the plurality of databases further comprises:
receiving a rating of the predefined retail product from the plurality of databases, the receiving a rating step further comprising displaying the rating; and
receiving a specification of the predefined retail product from the plurality of databases, the receiving the specification step further comprising displaying the specification.

9. The method of claim 9 further comprises indicating a set of locations from where the retail product can be purchased.

10. A system comprising:
at least one data sending module operable to send a retail product information;
a central server module configured to receive the retail product information from the at least one data sending server, the central server module further attached to a specific processor to process the retail product information;
a means for processing the retail product information at the central server module, wherein the central server module retrieves retail product information from at least one database which contains the retail product information through a communication channel;
at least one data receiving module configured to receive the retail product information from the central server module; and
at least one application server configured to accept input from a user, wherein the at least one application server is coupled with the at least one data receiving server.

11. The system of claim 10 further comprising a means for the central server module to communicate with the at least one database, wherein the at least one database are accessed using application program interface.

12. The system of claim 10 further comprising a display module configured to receive the retail product information from the at least one data receiving server.

13. The system of claim 10 further comprising an input system configured to accept at least one input from the user, wherein the at least one input is a marked retail product.

14. The system of claim 10 further comprises an application database coupled to the central server module, wherein augmented information of the marked retail product is retrieved from the application database.

15. The system of claim 14 wherein the augmented information corresponds to one or more of the following:
a three dimensional model of the marked retail product; and
a video clip of the marked retail product.

16. The system of claim 10 further comprises an information module wherein the information module is coupled with the central server module and the at least one data receiving module, the information allows the user to access the retail product information selectively.

17. The system of claim 16 wherein the information module further comprises:
a map coupled to the information module, wherein the map provides a geographical information of a location from which the marked retail product can be purchased;
a specification module coupled to the information module, wherein the specification module contains the detailed description of the marked retail product;
a feedback module coupled to the information module, wherein the feedback module comprises a review of the marked retail product; and
a price module coupled to the information module, wherein the price module comprises the range of cost of the marked retail product.

18. The system of claim 17 coupled to the display module to selectively display the marked retail product information when selected by the user.

19. A computer program product, comprising a machine-accessible medium having instructions encoded thereon for enabling a processor to perform the operations of:
programcode adapted for receiving a predefined retail product as an input through a digital device, the displaying the predefined retail product on an output display in the form of a three dimensional image;
programcode adapted for sending a predefined retail product metadata through a communication channel to a plurality of databases;
programcode adapted for receiving a processed predefined retail product information from the plurality of databases; and
programcode adapted for sharing the processed predefined retail product information to at least one application in real time.

20. The product of claim 19, further comprising program code adapted for displaying the predefined retail product information on request by a user.

21. The product of claim 19, further comprising program code adapted for receiving augmented information from an application database.

22. The product of claim 21, further comprising program code adapted for displaying the augmented information on the output display.

23. The product of claim 19, further comprising program code adapted for communicating with the plurality of databases using application program interface.
